(19) United States
(12) Patent Application Publication
(10) Pub. No.: US 2025/0112341 A1
(43) Pub. Date: Apr. 3, 2025

(54) SECONDARY BATTERY

(71) Applicant: MURATA MANUFACTURING CO., LTD., Kyoto (JP)

(72) Inventors: Masakazu MORIYAMA, Kyoto (JP); Shoichi NISHIYAMA, Kyoto (JP); Ippei WAKI, Kyoto (JP); Atsushi NEMOTO, Kyoto (JP)

(21) Appl. No.: 18/817,526

(22) Filed: Aug. 28, 2024

(30) Foreign Application Priority Data
Sep. 28, 2023 (JP) 2023-168605

(51) Int. Cl. H01M 50/538; H01M 10/0525

(52) U.S. Cl. CPC H01M 50/538; H01M 10/0525

(57) ABSTRACT

A secondary battery is provided and includes a first pole and a second pole both wound along a prescribed direction. A first current collector of the first pole has a first protrusion protruding along the prescribed direction and not overlapping a first active material layer of the first pole. A second current collector of the second pole has a second protrusion protruding along an orthogonal direction orthogonal to the prescribed direction and not overlapping a second active material layer of the second pole. The first tab is electrically connected to the first protrusion. The second tab is electrically connected to the second protrusion.

### CROSS REFERENCE TO THE RELATED APPLICATIONS

The present application claims priority to Japanese patent application no. 2023-168605, filed on Sep. 28, 2023, the entire contents of which are incorporated herein by reference.

### BACKGROUND

The present disclosure relates to a secondary battery.

In a lithium secondary battery disclosed, a positive electrode current collector and a negative electrode current collector constitute a flat electrode body. A current collecting tab of the positive electrode current collector and a current collecting tab of the negative electrode current collector are disposed on the outermost peripheral portion of the flat electrode body. At least one of the current collecting tab of the positive electrode current collector and the current collecting tab of the negative electrode current collector is disposed in parallel to the winding direction of the flat electrode body.

### SUMMARY

The present disclosure relates to a secondary battery.

In recent years, a secondary battery has been increasing in capacity and current. As the current enlargement of the secondary battery advances, the calorific value of the connection part between the current collector and the current collecting tab and the calorific value of the current collecting tab increase. As a solution thereto, it is desirable to increase the connection area between the current collector and the current collecting tab and the sectional area of the current collecting tab to reduce the calorific values. In addition, it is desirable that the two current collecting tabs are separated from each other in plan view along the thickness direction of a flat electrode body from the viewpoint of electrical insulation and the viewpoint of reduction in the calorific values.

However, in the lithium secondary battery (referenced in the Background section, both the current collecting tab in the positive electrode current collector and the current collecting tab in the negative electrode current collector are disposed on the outermost peripheral portion of the flat electrode body. Therefore, there is a possibility that connection areas between the current collectors and the current collecting tabs cannot be sufficiently ensured in a state where the two current collecting tabs are separated from each other. In addition, in a state where the two current collecting tabs are disposed to extend in parallel to each other, there is a possibility that the width of the current collecting tabs cannot be sufficiently ensured and the sectional areas of the current collecting tabs cannot be sufficiently ensured.

The present disclosure, in an embodiment, relates to providing a secondary battery capable of coping with current enlargement.

The secondary battery according to the present disclosure, in an embodiment, includes: an electrode body including a first pole, a second pole differing from the first pole in potential, and a separator disposed between the first pole and the second pole, in which the first pole, the second pole, and the separator are wound along a prescribed direction; a first tab electrically connected to the first pole; and a second tab electrically connected to the second pole, in which the first pole includes a first current collector in a foil shape and a first active material layer overlapping the first current collector and containing an active material of the first pole; the second pole includes a second current collector in a foil shape and a second active material layer overlapping the second current collector and containing an active material of the second pole; the first current collector integrally includes: a first body portion having a first side extending along a direction orthogonal to the prescribed direction in plan view in a state of being spread flat and overlapping the first active material layer; and a first protrusion protruding from the first side along the prescribed direction in plan view in a state of being spread flat and not overlapping the first active material layer, the second current collector integrally includes: a second body portion having a second side extending along the prescribed direction in plan view in a state of being spread flat, the second body portion overlapping the second active material layer; and a second protrusion protruding from the second side along a direction orthogonal to the prescribed direction in plan view in a state of being spread flat and not overlapping the second active material layer, the first tab is electrically connected to the first protrusion, and the second tab is electrically connected to the second protrusion.

With the secondary battery of the present disclosure, in an embodiment, it is possible to cope with an increase in current.

### BRIEF DESCRIPTION OF THE FIGURES

FIG. 1 is a plan view of a secondary battery according to an embodiment of the present disclosure;

FIG. 2 is an exploded perspective view of the secondary battery illustrated in FIG. 1;

FIG. 3 is a plan view of the electrode body illustrated in FIG. 2;

FIG. 4 is a sectional view of the electrode body taken along a line IX-IX indicated in FIG. 3;

FIG. 5 is a partial sectional view of a first pole;

FIG. 6 is a plan view illustrating the first current collector in a state of being spread flat;

FIG. 7 is a partial sectional view of a second pole;

FIG. 8 is a plan view illustrating the second current collector in a state of being spread flat;

FIG. 9 is a plan view of the electrode body according to a comparative example of an embodiment of the present disclosure;

FIG. 10 is a sectional view of the electrode body of the comparative example taken along line X-X indicated in FIG. 9;

FIG. 11 is a plan view illustrating a state where the second current collector of the second pole of the electrode body of the comparative example illustrated in FIG. 9 is spread flat;

FIG. 12 is a plan view of the electrode body of the secondary battery according to the first modification example of an embodiment of the present disclosure; and

FIG. 13 is a plan view illustrating the second current collector in a state of being spread flat in the secondary battery according to the second modification example of an embodiment of the present disclosure.

### DETAILED DESCRIPTION

Hereinafter, one or more embodiments will be described in further detail including with reference to the drawings. The present disclosure is not limited thereto. Each embodiment is illustrative, and replacement and combination of a part of configurations shown in the different embodiments can be performed.

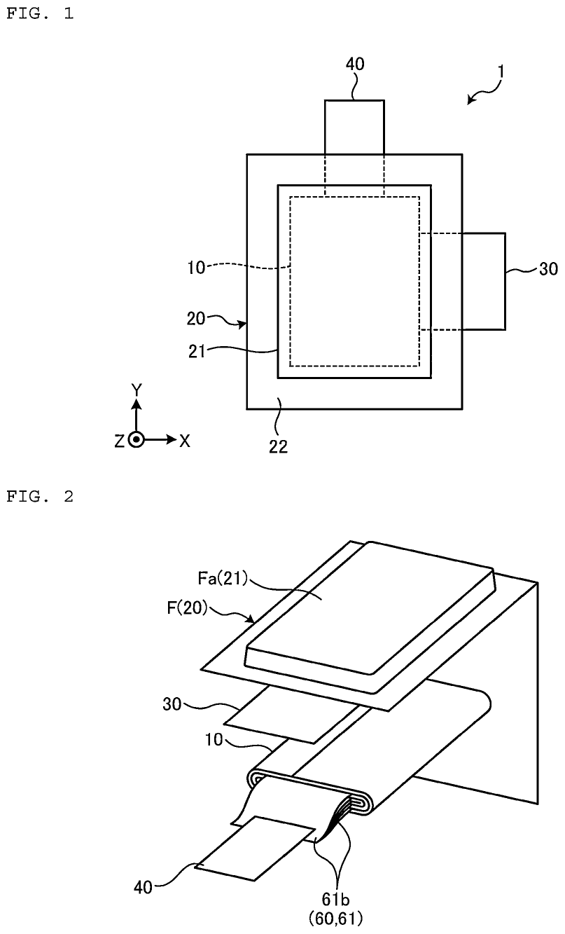

FIG. 1 is a plan view of a secondary battery 1 according to an embodiment of the present disclosure. FIG. 2 is an exploded perspective view of the secondary battery 1 illustrated in FIG. 1.

The secondary battery 1 is, for example, a lithium battery. The secondary battery 1 includes an electrode body 10, an exterior body 20, a first tab 30, and a second tab 40.

The exterior body 20 integrally includes a housing portion 21 and a flange portion 22. The housing portion 21 houses the electrode body 10. In addition, an electrolyte (for example, a non-aqueous electrolytic solution) is housed in the housing portion 21. The flange portion 22 extends over the entire periphery of the housing portion 21. In the plan view shown in FIG. 1, the peripheral edge of the flange portion 22 has a rectangular shape.

As illustrated in FIG. 2, the exterior body 20 is formed by folding one film F at a folding portion. In the film F before being folded, a projecting portion Fa is formed by press working, for example. The projecting portion Fa constitutes the housing portion 21. The film F is folded in a state where the electrode body 10 and the electrolyte are housed inside the projecting portion Fa. Portions where the film F overlaps itself around the projecting portion Fa are joined to form the flange portion 22.

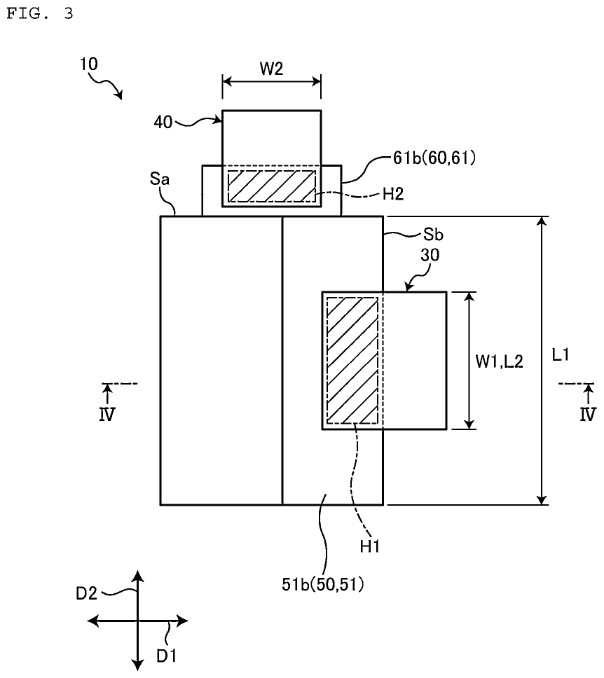

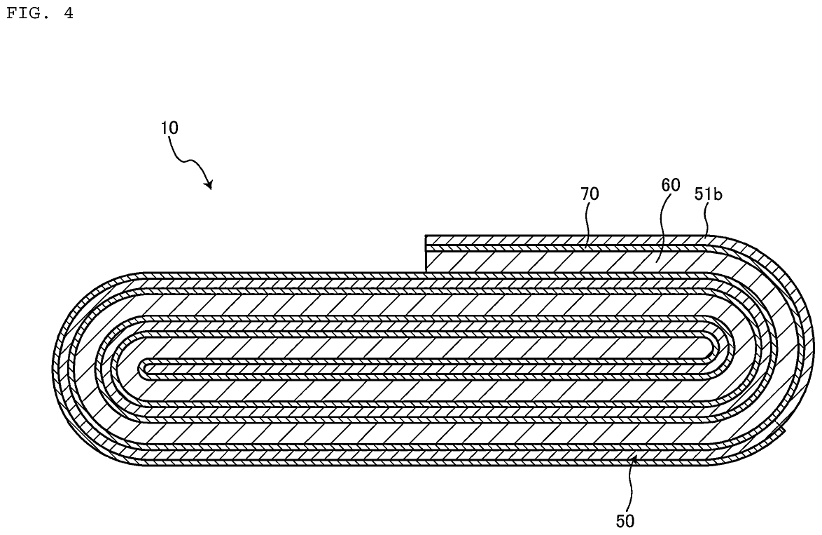

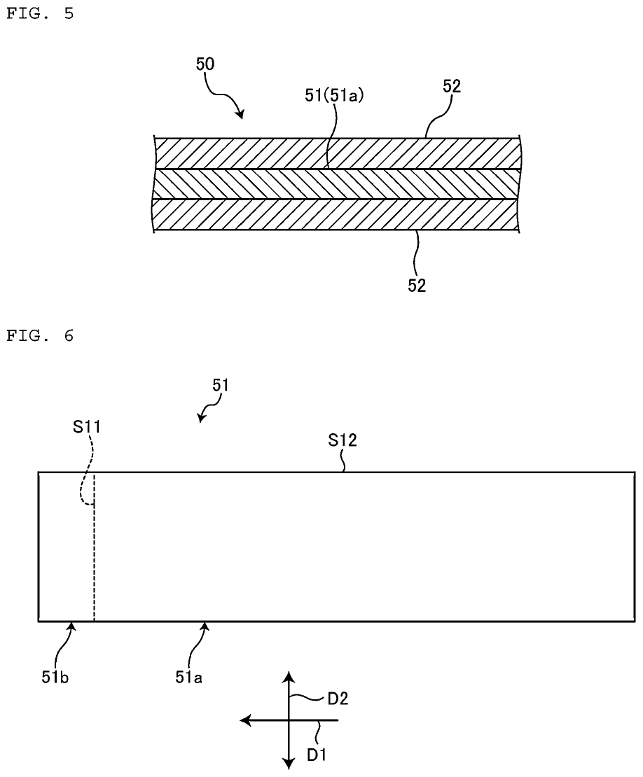

FIG. 3 is a plan view of the electrode body 10 illustrated in FIG. 2. FIG. 4 is a sectional view of the electrode body 10 taken along the line IX-IX indicated in FIG. 3. In FIG. 3 are indicated a prescribed direction D1, described later, and an orthogonal direction D2 orthogonal to the prescribed direction D1.

The electrode body 10 is a wound-type electrode body. The electrode body 10 includes a first pole 50, a second pole 60, and a separator 70 as illustrated in FIG. 4. The first pole 50 is a positive electrode. The second pole 60 is a negative electrode. The first pole 50 and the second pole 60 differ in potential.

Each of the first pole 50, the second pole 60, and the separator 70 is in a sheet shape. The first pole 50, the separator 70, and the second pole 60 are stacked in this order. That is, the separator 70 is disposed between the first pole 50 and the second pole 60. The separator 70 electrically insulates the first pole 50 from the second pole 60.

The first pole 50, the second pole 60, and the separator 70 are wound along a prescribed direction D1. The prescribed direction D1 is a counterclockwise direction in FIG. 4.

FIG. 5 is a partial sectional view of the first pole 50. The first pole 50 includes a first current collector 51 and a first active material layer 52.

The first current collector 51 is in a foil shape. As the material of the first current collector 51, for example, aluminum is used.

FIG. 6 is a plan view illustrating the first current collector 51 in a state of being spread flat. In other words, the first current collector 51 illustrated in FIG. 6 is not wound along the prescribed direction D1 and is in a flat state. The prescribed direction D1 is a direction in which the arrow shown in FIG. 6 extends. The side indicated by the arrow shown in FIG. 6 corresponds to the outside of the electrode body 10 in a state where the first pole 50 is wound. The first current collector 51 integrally includes a first body portion 51a and a first protrusion 51b.

The first body portion 51a has a rectangular shape with the prescribed direction D1 as a longitudinal direction. The first body portion 51a has a primary first side S11 (corresponding to a “first side”) and a primary second side S12 in the plan view of the first body portion 51a illustrated in FIG. 6. The primary first side S11 extends along the orthogonal direction D2 and is positioned outside the electrode body 10 in a state where the first pole 50 is wound. The primary second side S12 extends along the prescribed direction D1. That is, the primary first side S11 and the primary second side S12 are orthogonal to each other. The primary second side S12 overlaps the side Sa of the electrode body 10 in the plan view shown in FIG. 3.

In the plan view shown in FIG. 6, the first protrusion 51b has a rectangular shape protruding from the primary first side S11 along the prescribed direction D1. In the orthogonal direction D2, the length of the first protrusion 51b is equal to the length of the first body portion 51a. The first protrusion 51b is positioned outside the electrode body 10 as illustrated in FIGS. 3 and 4.

The first active material layer 52 illustrated in FIG. 5 is disposed on both surfaces of the first body portion 51a. In a plan view of the first pole 50 in a state where the first pole 50 is spread flat, a peripheral edge of the first body portion 51a and a peripheral edge of the first active material layer 52 overlap each other. That is, in a state where the first pole 50 is spread flat, the first active material layer 52 has a rectangular shape with the prescribed direction D1 as a longitudinal direction. The first active material layer 52 is not disposed on the first protrusion 51b.

The first active material layer 52 contains an active material of the first pole 50. The active material of the first pole 50 is preferably, for example, a lithium transition metal composite oxide. Examples of the lithium transition metal composite oxide include LiCoO₂, LiNiO₂, LiMn₂O₄, LiMnO₂, LiCo_{0.5}Ni_{0.5}O₂, and LiNi_{0.33}CO_{0.33}Mn_{0.34}O₂, and particularly, LiCoO₂ and a lithium transition metal composite oxide having a layered structure containing Li, Ni, Mn, and Co can be suitably used.

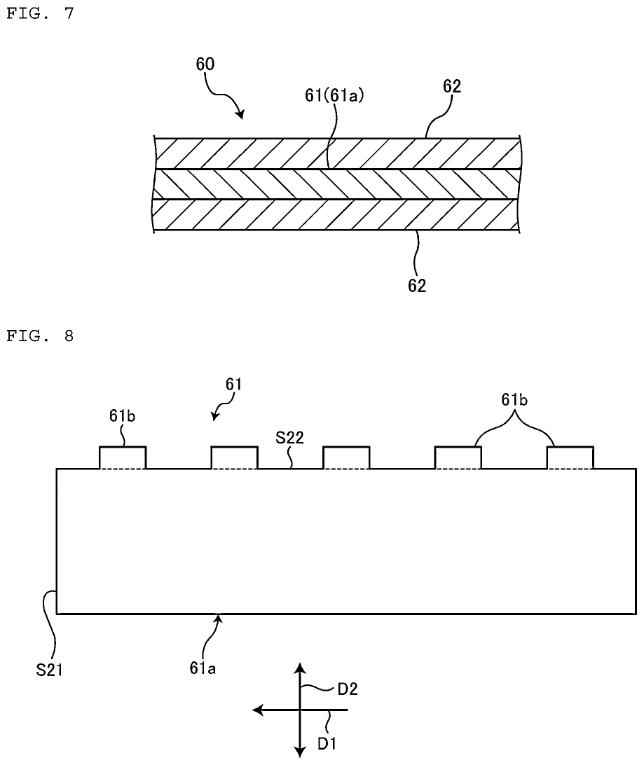

FIG. 7 is a partial sectional view of a second pole 60. The second pole 60 includes a second current collector 61 and a second active material layer 62.

The second current collector 61 is in a foil shape. As the material of the second current collector 61, for example, metal such as copper, nickel, iron, titanium, or cobalt, an alloy composed of a combination of metals, or a compound of metal is used.

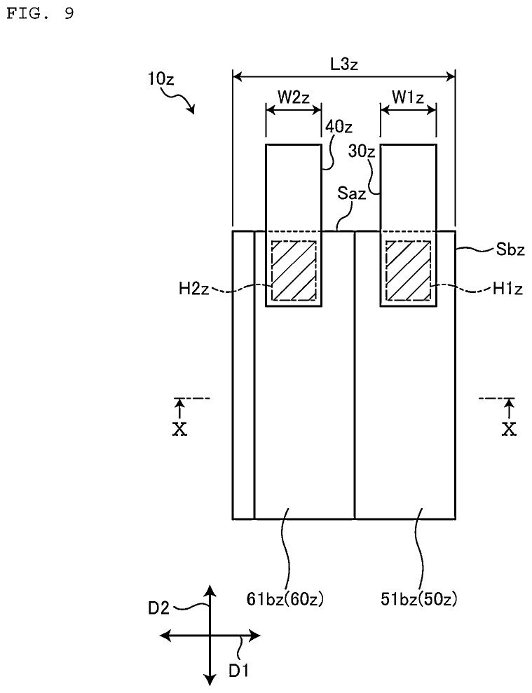

FIG. 8 is a plan view illustrating the second current collector 61 in a state of being spread flat. In other words, the second current collector 61 illustrated in FIG. 8 is not wound along the prescribed direction D1 and is in a flat state. The side indicated by the arrow indicating the prescribed direction D1 in FIG. 8 corresponds to the outside of the electrode body 10 in a state where the second pole 60 is wound. The second current collector 61 integrally includes a second body portion 61a and a second protrusion 61b.

The second body portion 61a is in a rectangular shape with the prescribed direction D1 as a longitudinal direction. The second body portion 61a has a secondary first side S21 and a secondary second side S22 (corresponding to “second side”) in the plan view of the second body portion 61a illustrated in FIG. 8. The secondary first side S21 extends along the orthogonal direction D2 and is positioned outside the electrode body 10 in a state where the second pole 60 is wound. The secondary second side S22 extends along the prescribed direction D1. That is, the secondary first side S21 and the secondary second side S22 are orthogonal to each other. The secondary second side S22 overlaps the side Sa of the electrode body 10 in the plan view shown in FIG. 3.

In the plan view shown in FIG. 8, the second protrusion 61b has a rectangular shape protruding from the secondary second side S22 along the orthogonal direction D2. There are a plurality of the second protrusions 61b. The plurality of the second protrusions 61b overlap each other in the plan view of the electrode body 10 shown in FIG. 3.

The second active material layer 62 illustrated in FIG. 7 is disposed on both surfaces of the second body portion 61a. In a plan view of the second pole 60 in a state where the second pole 60 is spread flat, a peripheral edge of the second body portion 61a and a peripheral edge of the second active material layer 62 overlap each other. That is, in a state where the second pole 60 is spread flat, the second active material layer 62 has a rectangular shape with the prescribed direction D1 as a longitudinal direction. The second active material layer 62 is not disposed on the second protrusion 61b.

The second active material layer 62 contains an active material of the second pole 60. As the active material of the second pole 60, for example, silicon is used.

In the plan views shown in FIGS. 1 and 3, the first tab 30 has a rectangular flat plate shape. As the material of the first tab 30, for example, aluminum is used. The first tab 30 is electrically connected to the first pole 50.

Specifically, the first tab 30 is electrically connected to the first protrusion 51b by, for example, laser welding, resistance welding, vibration welding, or the like. In the plan view shown in FIG. 3, a range in which the first tab 30 and the first protrusion 51b are electrically connected (hereinafter, referred to as first range H1) is indicated with hatching.

In addition, the first tab 30 is disposed in a state of extending along the prescribed direction D1. In the plan views shown in FIGS. 1 and 3, the transverse direction of the first tab 30 is along the prescribed direction D1. As illustrated in FIG. 1, a part of the first tab 30 is exposed to the outside. The first tab 30 is sandwiched by the exterior body 20.

The second tab 40 has a rectangular flat plate shape in the plan views shown in FIGS. 1 and 3. As the material of the second tab 40, for example, nickel is used. The second tab 40 is electrically connected to the second pole 60.

Specifically, the plurality of the second protrusions 61b are electrically connected to each other by, for example, laser welding, resistance welding, vibration welding, or the like, and the second tab 40 is electrically connected to at least one second protrusion 61b of the plurality of the second protrusions 61b by, for example, laser welding, resistance welding, vibration welding, or the like. In the plan view shown in FIG. 3, a range in which the second tab 40 and the second protrusion 61b are electrically connected (hereinafter, referred to as second range H2) is indicated with hatching.

In addition, the second tab 40 is disposed in a state of extending along the orthogonal direction D2. In the plan views shown in FIGS. 1 and 3, the longitudinal direction of the second tab 40 is along the orthogonal direction D2. As illustrated in FIG. 1, a part of the second tab 40 is exposed to the outside. The second tab 40 is sandwiched by the exterior body 20.

In the plan view shown in FIG. 1, the side overlapping the first tab 30 and the side overlapping the second tab 40 are adjacent to each other at the peripheral edge of the flange portion 22. In the plan view of the electrode body 10 shown in FIG. 3, the side Sa of the electrode body 10 faces the second tab 40, and the side Sb of the electrode body 10 overlaps the first tab 30. In the plan view shown in FIG. 3, the side Sa and the side Sb are adjacent to each other.

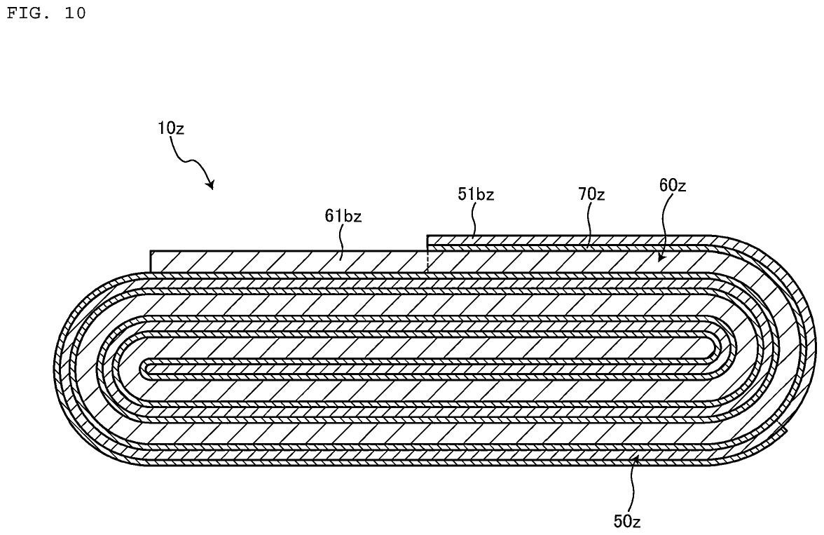

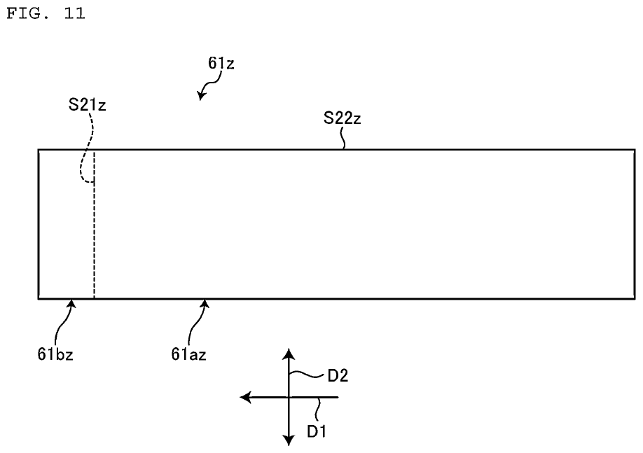

FIG. 9 is a plan view of the electrode body 10z according to the comparative example of an embodiment of the present disclosure. FIG. 10 is a sectional view of the electrode body 10z of the comparative example taken along line X-X shown in FIG. 9. FIG. 11 is a plan view illustrating a state in which the second current collector 61z of the second pole 60z included in the electrode body 10z of the comparative example illustrated in FIG. 9 is spread flat.

The electrode body 10z of the comparative example differs from the electrode body 10 of an embodiment described herein. For example, in the reference numerals of the constituent members of the electrode body 10z of the comparative example, “z” is added to the end of the reference numerals of the constituent members of the electrode body 10 of an embodiment corresponding to the constituent members of the electrode body 10z of the comparative example. For example, the electrode body 10z includes a first pole 50z and a second pole 60z, the first pole 50z includes a first protrusion 51bz, and the second pole 60z includes a second protrusion 61bz.

The electrode body 10z of the comparative example is different from the electrode body 10 of an embodiment described herein. As compared with the electrode body 10 of an embodiment, the electrode body 10z of the comparative example differs in that the second protrusion 61bz of the second current collector 61z shown in FIG. 11 has a rectangular shape projecting from the secondary first side S21z along the prescribed direction D1, and is located outside the electrode body 10 as illustrated in FIGS. 9 and 10, and in that both the longitudinal direction of the first tab 30z and the longitudinal direction of the second tab 40 are along the orthogonal direction D2 as illustrated in FIG. 9, and both the first tab 30z and the second tab 40z overlap the side Saz.

The first tabs 30 and 30z and the second tabs 40 and 40z need to be electrically insulated and cannot overlap each other in the plan views shown in FIGS. 3 and 9. Therefore, in the plan view of the electrode body 10z of the comparative example shown in FIG. 9, the first tab 30z and the second tab 40z overlap the same side Saz in the electrode body 10z, and are adjacent to each other in a state of being separated from each other.

On the other hand, in the plan view of the electrode body 10 of an embodiment shown in FIG. 3, the second tab 40 faces the side Sa of the electrode body 10, and the first tab 30 overlaps the side Sb of the electrode body 10. Therefore, in the plan views shown in FIGS. 3 and 9, with respect to the lengths W2 and W2z in the width direction orthogonal to the direction in which the second tabs 40 and 40z extend, the length W2 of the second tab 40 of an embodiment can be made larger than the length W2z of the second tab 40z of the comparative example.

As described herein, in the plan view of the electrode body 10z of the comparative example shown in FIG. 9, the first tab 30z and the second tab 40z overlap the same side Saz in the electrode body 10z, and are adjacent to each other in a state of being separated from each other. On the other hand, in the plan view of the electrode body 10 of an embodiment shown in FIG. 3, the second tab 40 faces the side Sa of the electrode body 10, and the first tab 30 overlaps the side Sb of the electrode body 10. Furthermore, in the plan views shown in FIGS. 3 and 9, the sides Sb and Sbz are longer than the sides Sa and Saz. Therefore, in the plan views shown in FIGS. 3 and 9, with respect to the lengths W1 and W1z in the width direction orthogonal to the direction in which the first tabs 30 and 30z extend, the length W1 of the first tab 30 of an embodiment can be made larger than the length Wiz of the first tab 30z of the comparative example.

Therefore, with respect to the sectional areas of the second tabs 40 and 40z in the plane orthogonal to the direction in which the second tabs 40 and 40z extend and the sectional areas of the first tabs 30 and 30z in the plane orthogonal to the direction in which the first tabs 30 and 30z extend, the first tabs 30 and the second tabs 40 of the electrode body 10 of an embodiment can be made larger than the first tabs 30z and the second tabs 40z of the electrode body 10z of the comparative example.

The direction in which the first tab 30 extends (namely, the prescribed direction D1) is the same as the direction in which the current flows in the first tab 30. The direction in which the second tab 40 extends (namely, the orthogonal direction D2) is the same as the direction in which the current flows in the second tab 40. Therefore, at the time of charge and discharge of the secondary battery 1, with respect to the calorific value of the second tab 40 and the calorific value of the first tab 30, those of the first tab 30 and the second tab 40 of the electrode body 10 of an embodiment can be suppressed more than those of the first tab 30z and the second tab 40z of the electrode body 10z of the comparative example. Therefore, the secondary battery 1 of an embodiment can cope with current enlargement as compared with the secondary battery 1 including the electrode body 10z of the comparative example.

In addition, in the plan view shown in FIG. 3, a ratio of the length L2 along the orthogonal direction D2 in the first tab 30 (equal to the length W1; hereinafter also referred to as second length L2) to the length L1 in the width direction along the orthogonal direction D2 orthogonal to the prescribed direction D1 in the first protrusion 51b (hereinafter also referred to as first length L1) is 0.3 or more.

As described herein, in the plan view of the electrode body 10z of the comparative example shown in FIG. 9, the first tab 30z and the second tab 40z are adjacent to each other in a state of being separated from each other on the same side Saz of the electrode body 10. In the plan view shown in FIG. 9, when the length W1z in the width direction of the first tab 30z and the length W2z in the width direction of the second tab 40z are equal to each other, the ratio of the length W1z in the width direction of the first tab 30z to the length L3z of the side Saz of the electrode body 10z on which the first tab 30z and the second tab 40z overlap is smaller than 0.3. The length L3z of the side Saz of the electrode body 10z illustrated in FIG. 9 is equal to the length of the side Sa of the electrode body 10 illustrated in FIG. 3. Further, in the plan view of the electrode body 10 shown in FIG. 3, the side Sb is longer than the side Sa.

Therefore, in the electrode body 10 of an embodiment, when the ratio of the second length L2 of the first tab 30 to the first length L1 of the first protrusion 51b is 0.3 or more, the length W1 of the first tab 30 of an embodiment can be surely made larger than the length W1z of the first tab 30z of the comparative example in the plan views shown in FIGS. 3 and 9. Therefore, the secondary battery 1 of an embodiment can cope with current enlargement as compared with the secondary battery 1 including the electrode body 10z of the comparative example.

The ratio of the second length L2 along the orthogonal direction D2 in the first tab 30 to the first length L1 along the orthogonal direction D2 orthogonal to the prescribed direction D1 in the first protrusion 51b is 0.9 or less.

If in the case where the ratio of the second length L2 to the first length L1 is larger than 0.9, when an external force such as an impact acts on the secondary battery 1, if the first tab 30 presses the electrode body 10 and the peripheral edge of the electrode body 10 is thereby deformed, the first pole 50 and the second pole 60 may be short-circuited. Accordingly, in the secondary battery 1 of an embodiment, owing to setting the ratio of the second length L2 to the first length L1 to 0.9 or less, deformation of the peripheral edge of the electrode body 10 is inhibited also when the first tab 30 presses the electrode body 10 in response to the action of an external force on the secondary battery 1. Therefore, a short circuit between the first pole 50 and the second pole 60 can be inhibited.

As described herein, the length W1 of the first tab 30 of the electrode body 10 of an embodiment can be made larger than the length W1z of the first tab 30z of the electrode body 10z of the comparative example. Further, the length of the side Sb overlapping the first tab 30 in the plan view of the electrode body 10 of an embodiment shown in FIG. 3 is longer than the length of the side Saz overlapping the first tab 30z in the plan view of the electrode body 10z of the comparative example shown in FIG. 9. Therefore, the first range H1 of the electrode body 10 of an embodiment can be made larger than the first range H1z of the electrode body 10z of the comparative example.

As described herein, the length W2 of the second tab 40 of the electrode body 10 of an embodiment can be made larger than the length W2z of the second tab 40z of the electrode body 10z of the comparative example. Further, the length of the side Sa facing the second tab 40 in the plan view of the electrode body 10 of an embodiment shown in FIG. 3 is equal to the length of the side Saz overlapping the second tab 40z in the plan view of the electrode body 10z of the comparative example shown in FIG. 9. Therefore, the second range H2 of the electrode body 10 of an embodiment can be made larger than the second range H2z of the electrode body 10z of the comparative example.

Accordingly, the calorific value in the first range H1 and the calorific value in the second range H2 of the electrode body 10 of an embodiment at the time of charge and discharge of the secondary battery 1 can be suppressed more than the calorific value in the first range H1z and the calorific value in the second range H2z of the electrode body 10z of the comparative example. Therefore, the secondary battery 1 of an embodiment can cope with current enlargement as compared with the secondary battery including the electrode body 10z of the comparative example.

Note that embodiments described herein are intended to facilitate understanding of the present disclosure, but not intended to construe the present disclosure in any limited way. The present disclosure may be modified/improved without departing from the spirit thereof, and the present disclosure includes equivalents thereof.

For example, the first pole 50 may be a negative electrode, and the second pole 60 may be a positive electrode.

In the plan view of the electrode body 10 shown in FIG. 3, the length of the side Sb may be shorter than the length of the side Sa. In this case, in the plan view of the electrode body 10z shown in FIG. 9, the length of the side Sbz is shorter than the length of the side Saz.

In addition, in the plan view shown in FIG. 3, the first tab 30 may be disposed such that the longitudinal direction of the first tab 30 is along the prescribed direction D1. Further, the second tab 40 may be disposed such that the transverse direction of the second tab 40 is along the orthogonal direction D2.

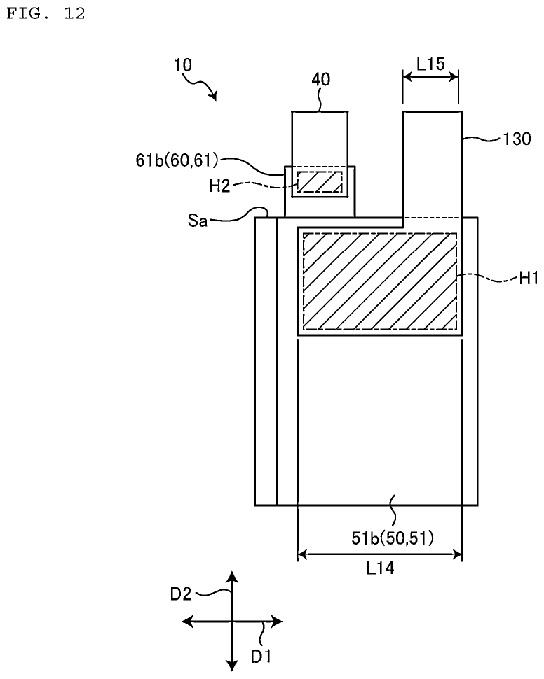

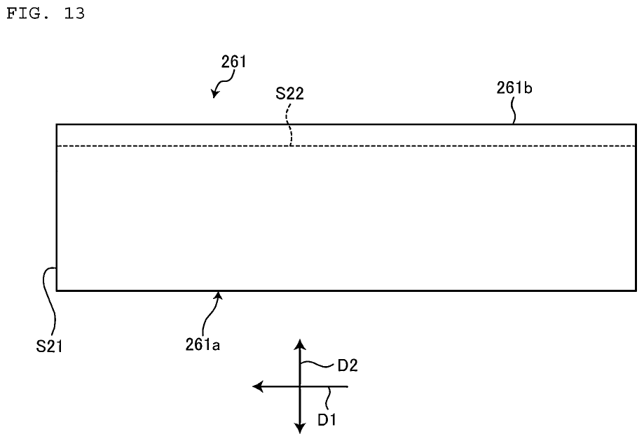

FIG. 12 is a plan view of the electrode body 10 of the secondary battery 1 according to the first modification example of an embodiment of the present disclosure. The electrode body 10 of the first modification example is different from the electrode body 10 of an embodiment described above in that the first tab 130 overlaps the side Sa of the electrode body 10. In addition, in the first modification example, the first tab 130 is formed such that the length L14 along the prescribed direction D1 of the first range H1 is longer than the length L15 along the prescribed direction D1 of the portion of the first tab 130 not overlapping the first pole 50.

Accordingly, also when the first tab 130 overlaps the side Sa of the electrode body 10 in the plan view of FIG. 12, it is possible to suppress the calorific value of the first range H1.

FIG. 13 is a plan view illustrating the second current collector 261 in a state of being spread flat in the secondary battery 1 according to the second modification example of an embodiment of the present disclosure. The second current collector 261 has one second protrusion 261b. The second protrusion 261b has a rectangular shape protruding along the orthogonal direction D2 from the entire of the secondary second side S22. In the second modification example, the second tab 40 is electrically connected to the second protrusion 61b wound along the prescribed direction D1.

Note that the present disclosure may be a combination of the following configurations in an embodiment.

(1)

A secondary battery including:
an electrode body including a first pole, a second pole differing from the first pole in potential, and a separator disposed between the first pole and the second pole, in which the first pole, the second pole, and the separator are wound along a prescribed direction;
a first tab electrically connected to the first pole; and
a second tab electrically connected to the second pole,
in which
the first pole includes a first current collector in a foil shape and a first active material layer overlapping the first current collector and containing an active material of the first pole;
the second pole includes a second current collector in a foil shape and a second active material layer overlapping the second current collector and containing an active material of the second pole;
the first current collector integrally includes:
a first body portion having a first side extending along a direction orthogonal to the prescribed direction in plan view in a state of being spread flat and overlapping the first active material layer; and
a first protrusion protruding from the first side along the prescribed direction in plan view in a state of being spread flat and not overlapping the first active material layer, the second current collector integrally includes:
a second body portion having a second side extending along the prescribed direction in plan view in a state of being spread flat, the second body portion overlapping the second active material layer; and
a second protrusion protruding from the second side along a direction orthogonal to the prescribed direction in plan view in a state of being spread flat and not overlapping the second active material layer,
the first tab is electrically connected to the first protrusion, and
the second tab is electrically connected to the second protrusion.

(2)

The secondary battery according (1), in which the first tab is disposed in a state of extending along the prescribed direction, and
the second tab is disposed in a state of extending along a direction orthogonal to the prescribed direction.

(3)

The secondary battery according to (1) or (2), in which a ratio of a second length along a direction orthogonal to the prescribed direction in the first tab to a first length along a direction orthogonal to the prescribed direction in the first protrusion is 0.3 or more.

(4)

The secondary battery according to any one of (1) to (3), in which a ratio of a second length along a direction orthogonal to the prescribed direction in the first tab to a first length along a direction orthogonal to the prescribed direction in the first protrusion is 0.9 or less.

(5)

The secondary battery according to any one of (1) to (4), in which the second current collector includes a plurality of the second protrusions.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery including:
an electrode body including a first pole, a second pole differing from the first pole in potential, and a separator disposed between the first pole and the second pole, in which the first pole, the second pole, and the separator are wound along a prescribed direction;
a first tab electrically connected to the first pole; and
a second tab electrically connected to the second pole,
in which
the first pole includes a first current collector in a foil shape and a first active material layer overlapping the first current collector and containing an active material of the first pole;
the second pole includes a second current collector in a foil shape and a second active material layer overlapping the second current collector and containing an active material of the second pole;
the first current collector integrally includes:
a first body portion having a first side extending along a direction orthogonal to the prescribed direction in plan view in a state of being spread flat and overlapping the first active material layer; and
a first protrusion protruding from the first side along the prescribed direction in plan view in a state of being spread flat and not overlapping the first active material layer,
the second current collector integrally includes:
a second body portion having a second side extending along the prescribed direction in plan view in a state of being spread flat, the second body portion overlapping the second active material layer; and
a second protrusion protruding from the second side along a direction orthogonal to the prescribed direction in plan view in a state of being spread flat and not overlapping the second active material layer,
the first tab is electrically connected to the first protrusion, and
the second tab is electrically connected to the second protrusion.

2. The secondary battery according to claim 1, wherein
the first tab is disposed in a state of extending along the prescribed direction, and
the second tab is disposed in a state of extending along a direction orthogonal to the prescribed direction.

3. The secondary battery according to claim 1, wherein a ratio of a second length along a direction orthogonal to the prescribed direction in the first tab to a first length along a direction orthogonal to the prescribed direction in the first protrusion is 0.3 or more.

4. The secondary battery according to claim 1, wherein a ratio of a second length along a direction orthogonal to the prescribed direction in the first tab to a first length along a direction orthogonal to the prescribed direction in the first protrusion is 0.9 or less.

5. The secondary battery according to claim 1, wherein the second current collector includes a plurality of the second protrusions.
